(19) United States
(12) Patent Application Publication
(10) Pub. No.: US 2006/0031877 A1
(43) Pub. Date: Feb. 9, 2006

(54) Method and system for movie clip search according to the word of synopsis

(75) Inventors: Hooi-Ling Yeo, Penang (MY); Shih-Hsiung Weng, Taipei City (TW)

Correspondence Address: BIRCH STEWART KOLASCH & BIRCH, PO BOX 747, FALLS CHURCH, VA, 22040-0747, US

(73) Assignee: INVENTEC MULTIMEDIA & TELECOM CORPORATION

(21) Appl. No.: 11/038,087

(22) Filed: Jan. 21, 2005

(30) Foreign Application Priority Data
Jun. 30, 2004 (TW) 093119673

(51) Int. Cl. H04N 5/445

(52) U.S. Cl. 725/41

(57) ABSTRACT

A method and system of searching for a movie clip according to a word in the synopsis. The user clicks on a word in the synopsis and the Web browser will connect to the movie trailer preview Web site that is providing the movie trailer through the internet from the internet component of the PC system, and then the word read module will analyze the WebPages to determine whether the word is a preset search word. If the clicked word is a preset search word, then the word read module will acquire the corresponding code according to the preset search word. Then, the frame look up module will find the data to at least one frame store location that corresponds to the code. Thus, the movie player module will play the movie clip according to the data.

### BACKGROUND OF THE INVENTION

1. Field of the Invention

The present invention generally related to a method for movie clip search according to the word of synopsis and the device thereof, and more particularly to a method for movie clip search according to word of synopsis to search and the system thereof.

2. Description of the Prior Art

In present Internet trends, the software which provides the movie trailer preview function such as Quick time, which was developed by the Apple Company is applied to movie trailers on the Apple Web site to preview the selected movie trailer. These movie trailers were edited in advance from the movie production team and distributed for users to preview. These movie trailers have short essays called a synopsis that introduce the movie content. The shortcoming lies in the fact that the playtime of these movie trailers are too short and the movie trailer can't be played from a specific frame which the user wants to select, hence the movies' selling point can't be identified in the short amount of time.

### SUMMARY OF THE INVENTION

Since a user can't select specific points or frames in movie trailers, the movie's selling point can't obviously be recognized personally by the user. The present invention provides a method, which searches within movie clips according to a specific word from the synopsis, thus connecting to the corresponding frame to begin play based on the word, so as to let the user preview the movie's selling point.

Another purpose of the present invention is to search within a movie clip according to the user inputted keyword about the movie, and to play the corresponding part of the movie clip based on the searched frame.

The purpose of the present invention is to further find the corresponding frame in different movies of the movie database to play, according to the user inputted keyword and the corresponding search code.

According to the above-mentioned purpose, the present invention provides a method and system, which searches within movie clips according to a specific word in the synopsis. Once the user connects to the movie trailer preview Web site through the internet from the internet component of the PC system, and the user clicks on the selected word of the synopsis, the word read module of the Web browser will analyze the Web page function to determine whether the selected word is a preset search word. If the selected word is a presetting search word, then the word read module would acquire the corresponding code according to the preset search word. Then, the frame searching module will find the frame store location that corresponds to the code. If there is more than one location of the stored frame, which means that the same scene appears more than once and appears at different times. Hence the frame searching module will search for the first scene in the time frame according to the code order of the link, and then the movie player module will play the movie according to the code order of the frame store location. Then, the Web page program will read the frame store locations to search and to get the corresponding frame. The notice message about the corresponding frame will be transmitted to the PC system through an Internet component via a Web site server. The movie player module will be executed to play the corresponding frame based on the keyword search.

### BRIEF DESCRIPTION OF THE DRAWINGS

FIG. 1 shows a synopsis with search program in accordance with the preferred embodiment of the present invention.

FIG. 2 is a flow diagram showing the search within a movie clip by selecting and clicking on a word of the synopsis in accordance with the preferred embodiment of the present invention.

FIG. 3 is a flow diagram showing the search within a movie clip by inputting a keyword in accordance with the preferred embodiment of the present invention.

FIG. 4 is a system block diagram showing the search within a movie clip with a word in accordance with preferred embodiment of the present invention.

FIG. 5 is a search system block diagram showing the search within a movie clip by inputting a keyword in accordance with the preferred embodiment of the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

The preview function that the Web site supports only provides the option of previewing the whole movie trailer, but the user is unable to arbitrarily select a specific point within the movie clip to play. Hence the user can't get to the movie's' selling point within the movie clip. Calling attention to the disadvantage of the present movie preview function, the present invention provides a method which not only enables the user to arbitrarily select the preview movie clips but also the user can input a keyword to search one or several movie clips to play. The advantage of the present invention is in providing the Web site that shows movie trailer previews the option to let the user access the movies selling point according to the user preference by selecting and clicking on the preset word search or the user inputs a keyword to search within the movie clips.

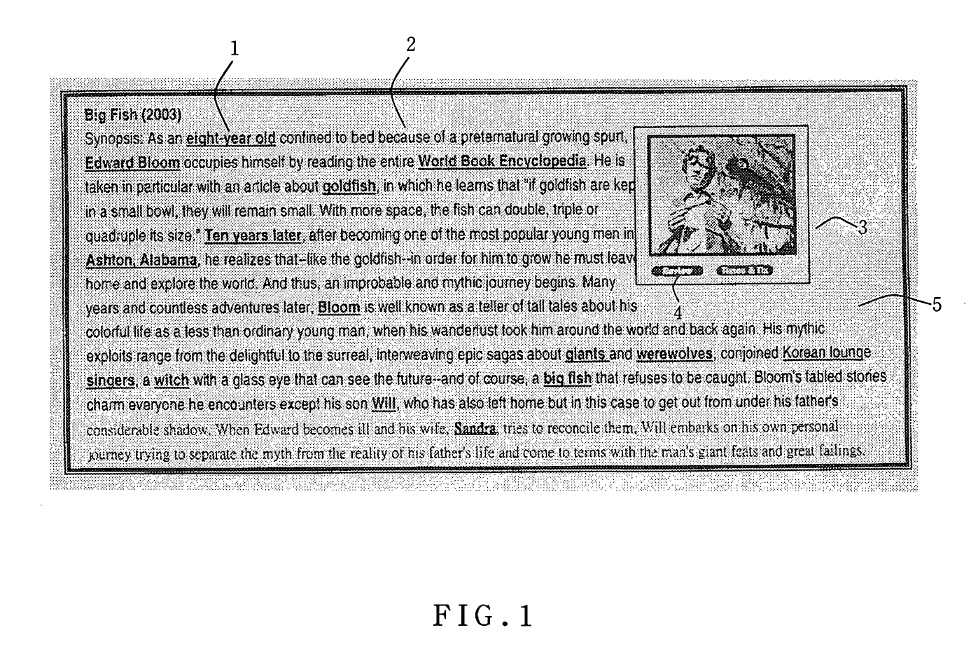

FIG. 1 shows a synopsis with a search program, in accordance with an embodiment of the present invention. When a Web page is applied, the method and system of the present invention is transmitted to a remote display device to display, the Web page will provide a frame 3 including the movie frame and the synopsis. In an embodiment, the frame 3 could be displayed with the Web page in the same window. In another embodiment, the frame 3 could also be displayed in another sub-window. The frame 3 includes a movie play area 4 and a synopsis area 5, the proportion and the location of the movie play area 4 and the synopsis area 5 are expressly not limited as specified in the FIG. 1. Furthermore, the movie play area 4 includes a movie display portion and a play control bar, the proportion and the location of the movie display portion and the play control bar are expressly not limited as specified in the FIG. 1.

In an embodiment, the synopsis area 5 includes a synopsis with a search program; the synopsis with a search program includes the presetting search word 1, and the presetting search word 1 is provided for the user to select and click. When the user uses the cursor tools such as a mouse or a wireless stylus to click on the presetting search word 1, the program will search for the corresponding frame to play according to the location data that corresponds with the preset search word 1. The preset search word 1 is appended underline or is presented with a different color or font style to be distinguished from the non-preset search word 2. Besides, the program won't search within a movie clip if the user clicks on a non-preset word 2. Furthermore, the display method of the preset search word 1 and non-preset search word 2 is not limited as the above-mentioned description, the display method which is provided for the user to prominently distinguish may be made without departing from the present invention.

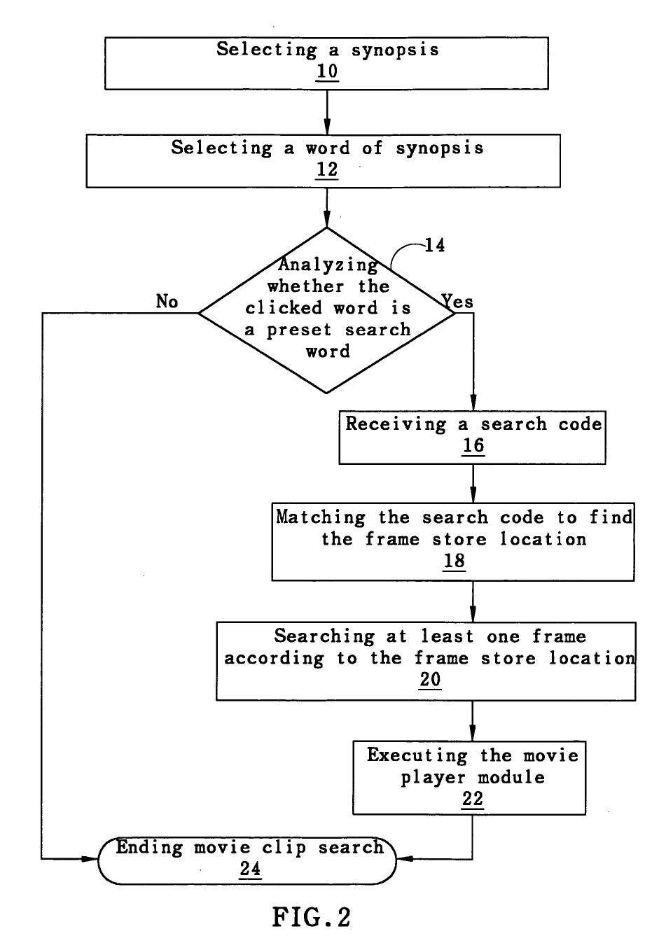

FIG. 2 is a flow diagram showing the search within a movie clip by selecting then clicking on a word from the synopsis in accordance with the present invention. At first, step 10 denotes that the user enters the URL address of the movies to be previewed, or the user selects and clicks on the synopsis of the movie to be previewed. The synopsis of the movie to be previewed could then be displayed by any appropriate method in the Web page such as a movie title, or poster etc; step 12 denotes that when a window is opened as shown in FIG. 1, the user can use any suitable input device such as a mouse to select a preset search word; step 14, to analyze whether the clicked word is a preset search word; If the clicked word is not a preset search word, then the search for the movie clip will be ended(step 24). If the clicked word is a preset search word, then in step 16 denotes that a search code will be received; in step 18, matching the search code to find the frame location where it's stored in step 20; searching at least one frame according to the frames stored location; step 22 denotes that executing the movie player module and in step 24, terminating the search for the movie clip.

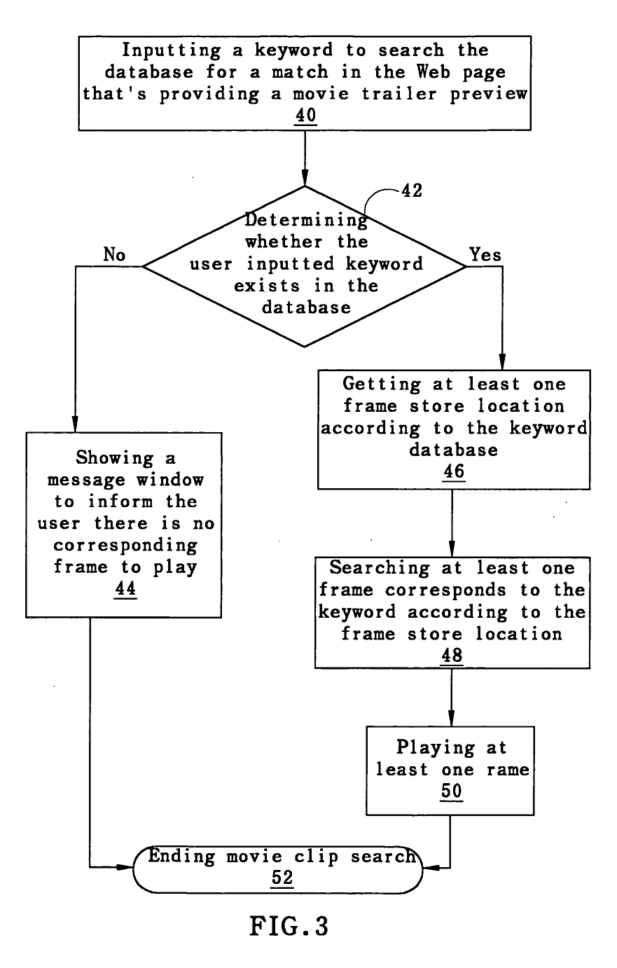

Moreover, FIG. 3 is a flow diagram showing the search within a movie clip by an inputted keyword in accordance with the preferred embodiment of the present invention. Step 40, the user inputs a keyword to search the database for a match in the Web page that's providing a movie trailer preview. Step 42, a search is performed in the movie trailer preview Web page to determine whether a match of the keyword inputted by the user exists in the keyword database. If the inputted keyword doesn't exist in the keyword database, a message window is displayed (step 44) to inform the user there is no corresponding frame to play, and the frame search will be ended (step 52). If the inputted keyword has a match in the keyword database, the user will be directed to the corresponding frame store location (step 46) and then performing a search for at least one frame corresponding to the keyword (step 48) in the frame store location. Completion of the search, allows the user to play at least one frame (step 50); then finally ending the movie clip search (step 52).

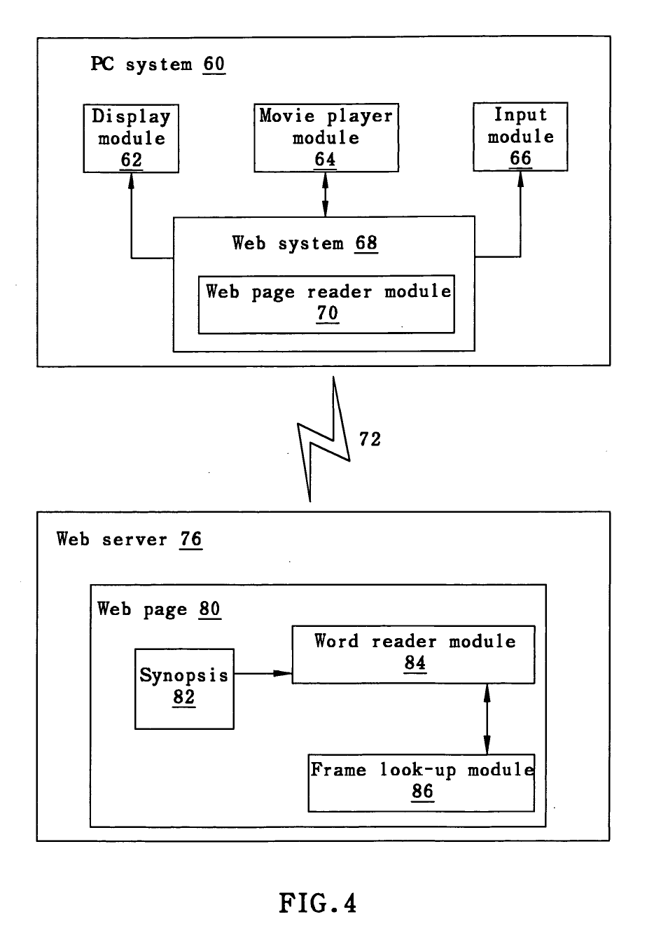

FIG. 4 is a system block diagram showing the search within a movie clip by selecting and clicking on word in the synopsis in accordance with the preferred embodiment of present invention. The search system includes a PC system 60 and a Web system 68. The PC system is used as the movie clip search operational system, which processes and manages the transmission of the signal and data among each module, or between the internal unit and external unit. The Web system provides the user a means to connect to the Internet. The PC system 60 includes a display module 62 for processing and displaying data; a movie player module 64 for playing the movie clip; a input module 66 for processing the keyword or command which is inputted by the user: for example, the user clicks on a preset search word in the synopsis; a Web system 68 for providing the user a means to connect to the Internet. A preferred embodiment for the present invention, in particular, the user could use the Internet to connect the PC system 60, thus providing the movie trailer preview Web page 80 such as the Apple Web site, via the Web system 68. The Web system 68 includes a Web page reader module 70 which decodes the program code of the Web page such as Html (Hyper Text Mark-up Language), C++, VB (Visual Basic Language) or Java script etc. The above-mentioned display module 62 and movie player module 64 connect to the Web system 68. Furthermore, the movie player module 64 and input module 66 connect to the Web system 68 separately.

Moreover, within the Internet, the Web page 80 of the movie trailer preview Web site includes a synopsis 82, the movie trailer preview Web page includes at least one synopsis 82 which has some preset search words; a word reader module 84, mainly reads the users selected and clicked on word to find the location of the stored frame. Furthermore, a frame look-up module 86, mainly finds the corresponding frame with the keyword according to the frame store location, which is found by the word reader module 84, and then the PC system 60 executes the internal movie player module 64 to orderly play the searched frames according to the search code order.

Furthermore, the search system further includes an Internet component 72, which connects the PC system 60 and the Web server 76 by a network communication protocol. The Internet component 72 could connect PC system 60 with another PC system, or connect with Web server 76 to a mutually transmitted data and signal.

Therefore, once the user uses the Web system 68 of the PC system 60 to connect with the Web site providing the movie trailer preview via the Internet component 72, the user clicks on the word of the synopsis 82 in the Web page providing the movie trailer preview, and then the word reader module 84 of the Web browser will decode the function of the Web page to analyze whether the user's clicked word is a preset search word. If the user's clicked word is not a preset search word, the movie clip search won't be executed. If the user's clicked word is a preset search word, the word reader module 84 will get the corresponding code according to the preset search word. Then, the frame look-up module 86 will find the corresponding code which is acquired by the word reader module 84 to get the location data of the movie frame in the Web site. If there is more than one location date, which means that the same scene appears more than one time and appears at different times. Hence the frame look-up module 86 will search the first time frame according to the code order of the location data, and then the movie player module 64 will play the movie according to the code order of the data. Then, the Web page program will read the location data to search and to get the corresponding frame. The notice message about the corresponding frame will be transmitted to the PC system 60 through an Internet component 72. The movie player module 64 will be executed accordingly to play the corresponding frame that is searched based on the searched keyword.

The advantages of the present invention are, not only the user can go straight to the selling point of the movie by clicking onto the preset search word, but also the movie frame searched by the keyword could offer the user messages about the movie without reading the whole synopsis as presently presented by the current movie trailer preview Web sites.

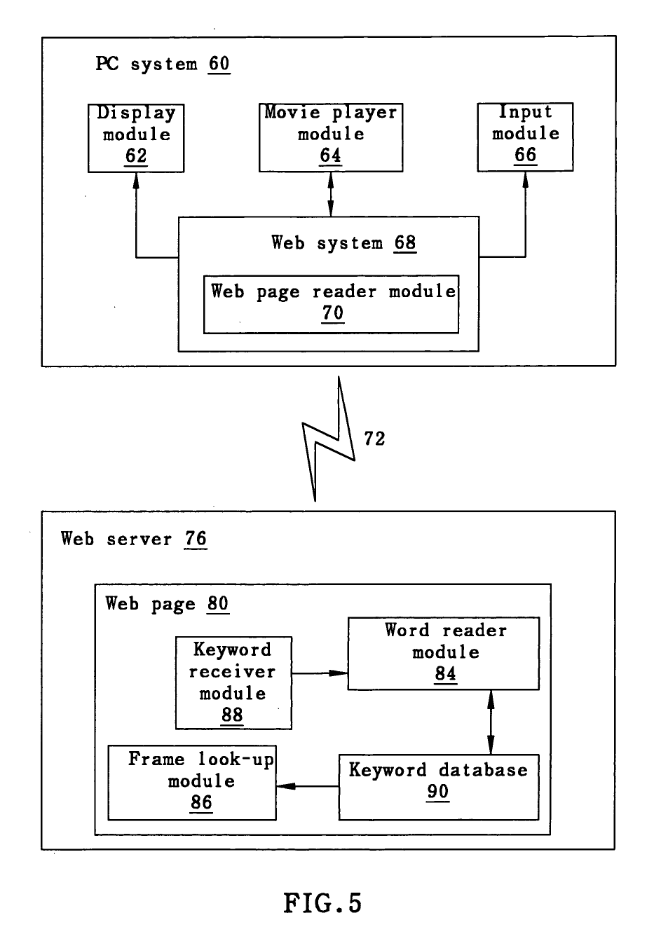

FIG. 5 is a search system block diagram showing a search for a movie clip with an inputted keyword in accordance with the preferred embodiment of the present invention. The search system as shown in FIG. 4 includes a PC system 60 and a Web system 68. The functions and the module of the search system won't be described here. In the embodiment, the user inputs the keyword in the movie trailer preview Web page 80. The keyword receiver module 88 of the Web page 80 receives the keyword input by the user, and then the word reader module 84 reads the inputted keyword to match keywords from the keyword database 90 in the Web site. If the inputted keyword does not exist in the keyword database 90, the Web page 80 will send a message to the PC system 60 through the Internet component 72, and the window of the Web page will display a message window to notify the user, that the corresponding frame to the keyword doesn't exist.

If the keyword inputted by the user does match a keyword in the keyword database 90, the corresponding search code to the keyword will be made available. And the frame store location will be found according to the search code. Furthermore, the frame search module 86 finds the corresponding frame based on the frame store location. The movie trailer preview Web site sends a message to the PC system 60 through the Internet component 72 and the Web server 76 then the movie player module 64 play the movie clip that starts at the searched frame.

The difference between the FIG. 5 and the FIG. 4 is that the method embodied in the FIG. 4 can only apply to one movie. And the user clicks on the preset word search in the Web page, which could only search the corresponding movie by the synopsis 82, because the synopsis 82 can only be matched with one movie; In FIG. 5, the search range for the preset search word is expanded to more than one movie. The user inputs a keyword that could match more then one frame or more than one frame in the keyword database 90. Hence the frame look-up module 86 could search through lots of data in the keyword database 90, and orderly play these movie clips that start at the searched frame according to the searched frame store locations.

As the above-mentioned description, whether clicking on the preset searched word, or inputting the keyword to search through the data, the present invention could break through the disadvantages of traditional method, of using HTML (Hyper Text Mark-up Language) could only link to one location. The link of the present invention is allows the user to link up with several frame store locations by getting a code to find all the corresponding data, not by directly receiving all the corresponding sources. Because major scenes repeatedly appeare in different frames, the data location of the different frames should be orderly collected so that the program can find the frame location, and then the program plays the movie clip according to the frame location.

Although specific embodiments have been illustrated and described, it will be obvious to those skilled in the art that various modifications may be made without departing from what is intended to limit solely by the appended claims.

What is claimed is:

1. A system for movie clip search according to the word of synopsis, said system comprising;
a display module for processing and displaying a frame data;
a movie player module for connecting with said display module to play a frame;
an input module for receiving a user inputted command;
a providing movie trailer preview Web page, wherein said Web page comprises a synopsis module with a presetting search word, said synopsis module receives said user inputted command; and a word reader module connecting said synopsis to get at least one search code according to said user inputted command and matching said search code in order to find at least one frame storing location; and
a frame look-up module for connecting with said word reader module to find corresponding said frame that according to said frame storing location, and said Web page used the Internet component to transmit said frame to said PC system via a Web server and executing said movie player module to play said frame.

2. The system according to claim 1, wherein said user inputted command is user selects at least one keyword of the synopsis.

3. The system according to claim 1, further comprising a Web page system with a Web page reader module, said Web page reader module used to decode a program code of said Web page, wherein said Web page reader module mutually connected with said display module and said input module.

4. A system for movie clip search according to the word of synopsis, said system comprising;
a display module for processing and displaying a frame data;
a movie player module for connecting with said display module to play a frame;
an input module for receiving a user inputted command;
a providing movie trailer preview Web page, said providing movie trailer preview Web page comprises a keyword receiver module; a keyword database connected with said synopsis module and stored a presetting search words; and a word reader module connected with said keyword database, and the user inputted keyword in said word reader module matches with said presetting search words of said keyword database to find at least one frame store location corresponding with said presetting search word; and
a frame look-up module connecting with said word reader module for finding at least one said corresponding frame according to said frame store location, and said providing movie trailer preview Web page uses the Internet component to transmit said frame to said PC system via a Web server and executes said movie player module to play said frame.

5. The system according to claim 4, further comprising a Web page system with a Web page reader module, said Web page reader module used to decode the program code of said Web page, said Web page reader module mutually connected with said display module and said input module.

6. The system according to claim 4, wherein said frames corresponding to said keywords is not to limit to one movie.

7. A storage device for storing several computer readable programs, said several computer readable programs perform a method for movie clip search according to the word of synopsis, said method comprising;
providing a synopsis having at least one presetting search word;
receiving a request of clicking said presetting search word;
getting at least one corresponding search code according to said presetting search word;
matching said search code to get at least one frame store location;
searching at least one frame corresponding to said presetting search word according to said frame store location; and
playing a movie clip which starts at said frame.

8. The method according to claim 7, wherein said synopsis corresponds to a movie.

9. The method according to claim 7, a keyword reader module in said storage device gets at least one search code corresponding to said presetting search word.

10. The method according to claim 7, wherein said matching said search code is performed by said word reader module of said storage device.

11. The method according to claim 7, wherein said searching at least one frame corresponding to said presetting search word is performed by a frame look-up module of said storage device.

12. The method according to claim 7, wherein said playing movie clip is performed by a movie player module of the PC system.

13. A storage device for storing several computer readable programs, said several computer readable programs perform a method for movie clip search according to the word of synopsis, said method comprising;
providing a providing movie trailer preview Web page having at least one keyword input module;
receiving an inputted keyword;
matching said inputted keyword to get at least one frame store location;
searching at least one frame corresponding to said inputted keyword according to said frame store location; and
playing a movie clip which starts at said frame.

14. The method according to claim 13, wherein said inputted keyword corresponds to at least one frame of one movie.

15. The method according to claim 13, wherein said inputted keyword corresponds to several frames of several movies.

16. The method according to claim 13, wherein said inputted keyword matches with keywords of the keyword database.

17. The method according to claim 13, wherein said matching said inputted keyword to get at least one frame store location is performed by a word reader module of said storage device.

18. The method according to claim 13, wherein said searching at least one frame corresponding to said inputted keyword according to said frame store location is performed by a frame look-up module of said storage device.

19. The method according to claim 13, wherein said playing at least one movie clip which starts at said frame is performed by a movie player module of the PC system.
